(19) United States
(12) Patent Application Publication
(10) Pub. No.: US 2022/0286480 A1
(43) Pub. Date: Sep. 8, 2022

(54) SYSTEM AND METHOD FOR SPECIFYING AND MANAGING PREDEFINED POLICIES FOR CONTAINERIZED WORKLOADS

(71) Applicant: ACCUKNOX, INC., Cupertino, CA (US)

(72) Inventors: RAHUL ARVIND JADHAV, Bangalore (IN); Phil Porras, Cupertino, CA (US); Asif Ali Shahjahan, El Dorado Hills, CA (US); Jaehyun Nam, Goyang-Si (KR); Seungsoo Lee, Dong-Gu (KR)

(21) Appl. No.: 17/689,981

(22) Filed: Mar. 8, 2022

Related U.S. Application Data
(60) Provisional application No. 63/158,164, filed on Mar. 8, 2021.

(51) Int. Cl. H04L 9/40

(52) U.S. Cl. CPC H04L 63/20

(57) ABSTRACT

A method and system for specifying and managing pre-defined policies for containerized workloads is provided. The system includes policy management module for receiving updates from an application developer, a specification of the policy profile for a containerized application and an associated link element and storing the container image containing the link element associated with the policy profile in a container registry of a policy server; a profile handler module which detects and monitors events of containerized applications, detects a link element associated with policy profile, fetches containerized application with link element from container registry and transmits policy profile to a policy controller module; and a policy controller module which obtains recommended policies of policy profile from policy server or a static file, screens recommended policies, receives updates from a security administrator and updates recommended policies in accordance with updates, and sends recommended policies to profile handler module.

### CROSS-REFERENCE TO RELATED APPLICATION

This application claims the priority and the continuation of the Provisional patent application with Ser. No. 63/158,164 filed at USPTO on Mar. 8, 2021, with the title, “POLICY SPECIFICATION AND MANAGEMENT FOR CONTAINERIZED WORKLOADS”, and the contents of which are incorporated in its entirety.

### BACKGROUND

### Technical Field

The embodiments herein, in general, are related to a field of cloud and containerized systems or applications. The embodiments herein are particularly related to a Manufacturer Usage Description (MUD) based access control method to containerized workloads and MUD-based standards to enable the manufacturers to specify the intended use of their Internet of things (IoT) devices in the form of a policy profile. More particularly, the embodiments herein are related to a system and a method for specifying and managing predefined policies for containerized workloads.

### Description of the Related Art

Typically, cloud and container systems deploy network and system policies to restrict accesses to resources. Identifying all such accesses and in turn, the policies is a non-trivial task. Immature identification techniques typically lead to false positives or at worse, may lead to insufficient protection of available resources. The principle of least privilege is typically followed to ensure that every module, for example, a process, a user, or a program, must be allowed access to only information and resources that are necessary for its legitimate purpose. Any organization that follows procedures such as the principle of least privilege would have to ensure identification of all resources and accesses to those resources and subsequently deploy the policies. In a conventional manual method for identifying resources and accesses to the resources, a user is typically aware of what the accesses are and would be needed to hand-code all policy enforcement rules. This manual method does not scale and is rife with deficiencies even for a small sized deployment. Applications may change on a regular basis and thus the policy enforcement rules must be updated manually, which is substantially error prone.

Another conventional method uses active telemetry/measurements in a data plane for identifying resources and accesses to the resources. In this method, a security system is deployed in a discovery mode for collecting information of active telemetry/measurements from all nodes and containers within the nodes in a cloud computing environment. This information is used to automatically identify all the resources and correlate their allowable accesses. This method, although widely used, requires instrumentation of the nodes with agents with privileged access. Instrumenting each node or host impacts performance in a data path. Moreover, an additional privileged application configured to monitor the data path for telemetry and measurements must be added into the security system, which itself creates a security risk. Furthermore, this method requires an auto-discovery module to be enabled at all times since the applications may be updated at a future point in time.

In the context of Internet-of-Things (IoT) networks, it is typically impractical to deploy an agent on the node for monitoring or for a telemetry purpose. Moreover, an IoT device typically has a particular function or an intended use case around which communication of the IoT device is modeled. Manufacturers of IoT devices advertise device specifications comprising intended communication patterns for each IoT device when the IoT device connects to a network using an embedded software standard, for example, Manufacturer Usage Description (MUD) defined by the Internet Engineering Task Force (IETF). MUD-based standards allow the manufacturers of IoT devices to specify the intended use of their IoT devices in the form of a policy profile. MUD-based standards provide a means for end devices to signal to the network the type of access and network functionality they require to properly function. In an MUD-based architecture, an IoT device sends a pre-embedded MUD-Uniform Resource Locator (URL) to a network infrastructure comprising network devices, for example, switches, Authentication, Authorization, and Accounting (AAA) servers in enterprise networks, etc. The IoT device signals the network about the MUD-URL using different methods, for example, a Dynamic Host Configuration Protocol (DHCP), a Link Layer Discovery Protocol (LLDP), or a certificate in an Institute of Electrical and Electronics Engineers (IEEE) 802.1X transaction. An MUD controller receives the MUD-URL through the network devices. The MUD controller resolves the MUD-URL and retrieves an abstract policy control file also referred to as an “MUD file” associated with the MUD-URL from a MUD file server. The MUD file comprises a recommendation and not a directive to an administrator to explain what access the IoT device is intended to have. The MUD controller translates the MUD file into a policy comprising enforceable network rules configured to be applied by a policy enforcement engine for allowing or restricting access to and from a resource, thereby substantially reducing a threat surface of the IoT device to merely the access that the IoT device was configured to have.

MUD is typically used in the context of IoT devices where the traffic and access patterns are predictable. There is a challenge in implementing MUD-based control on devices or entities such as desktops, smart phones, etc., that are configured to dynamically install new programs for new use cases, which cause traffic and access patterns to change frequently. Containerized applications have a specific purpose and specific access patterns. Orchestration platforms such as the Kubernetes® container-orchestration platform also referred to as K8s, impose specific deployment patterns to general purpose containers. There is a need for protecting containers from external and lateral threats and in turn, a need for enforcing least privilege policy settings. Conventional security solutions attempt to observe and monitor access patterns of each container in a node and then generate a set of recommended policies to apply to the container. However, these conventional security solutions require a host node to be instrumented to observe or monitor all the network traffic and other resources. Moreover, automatically discovered (auto-discovered) policies typically do not accurately cover all threat possibilities. The quality of auto-discovered policies is typically low, resulting in more false positives. Automatically detecting policies for containers is a cumbersome process requiring instrumentation that impacts node performance and requiring re-updating or re-discovery of policies due to changes/updates in containers.

Furthermore, to create a set of policies to protect a container/pod, there is a need to identify all the network flows and system calls made by that container. Identification of all the network flows and system calls involves runtime instrumentation of the container such that the network flows and system calls are intercepted and reported back to an aggregation engine. Such an aggregation engine typically discovers a common set of network and system controls based on the flow information over a period of time and generates a set of policy controls. The instrumentation used to intercept the flows and calls induces runtime overhead in the data path, that is, in the path where network input/output (IO) or disk IO operations occur, thereby increasing the impact on the data-plane performance.

Hence, there is a long felt need for a system and a method for specifying and managing predefined policies for containerized workloads that have specific purposes, specific access patterns, and deployment patterns, while addressing the above-recited problems associated with the related art.

The above-mentioned shortcomings, disadvantages and problems are addressed herein, and which will be understood by reading and studying the following specification.

### OBJECTIVES OF THE EMBODIMENTS HEREIN

A primary object of the embodiments herein is to provide a system and method for specifying and managing predefined policies for containerized workloads, also referred to as “containerized applications”, that have specific purposes, specific access patterns, and deployment patterns.

Another object of the embodiments herein is to provide a system and method for extending Manufacturer Usage Description (MUD)-based access control to containerized workloads, to enable a user such as an application developer to provides a specification of a policy profile defining one or more recommended policies for a containerized application via a policy management interface, associates a link element with the policy profile within a container image of the containerized application, and pushes the policies of the policy profile to the policy server.

Yet another object of the embodiments herein is to provide a system and method for receiving the specification of the policy profile for the containerized application and the associated link element via the policy management interface and stores the container image containing the link element associated with the policy profile in a container registry, and wherein the link element is a static URL that links to the policy profile, the policy server stores the recommended policies of the policy profile of the containerized application.

Yet another object of the embodiments herein is to develop a system and method for providing a profile handler to monitor and detect events of containerized applications, and the link element associated with the policy profile by scanning through container images in the container registry, to transmit the policy profile to the policy controller.

Yet another object of the embodiments herein is to develop a system and method for providing a policy controller to facilitate screening of the recommended policies of the policy profile. the policy controller receives updates, if any, to the recommended policies of the policy profile from a security administrator via the policy management interface; for receiving the updates from the security administrator via the policy management interface and updates the recommended policies in accordance with the updates; communicating with the policy enforcement engine directly to apply the recommended policies and allow or restrict access to and from the containerized application; and bypassing the profile handler and directly communicating with the policy enforcement engine for enforcement of the recommended policies.

Yet another object of the embodiments herein is to develop a system and method for providing a security administrator to modify or add additional rule sets to the recommended policies via the policy management interface and subsequently apply the recommended policies in context to the containerized application.

Yet another object of the embodiments herein is to develop a system and method for extending MUD-based profiles to containerized workloads in a Kubernetes® or K8s-native environment, to allow detection of link elements, for example, URLs and associated policy profiles from container images during a K8s pod startup, and to parameterize policy profiles.

Yet another object of the embodiments herein is to develop a system and method for auto-updating the MUD-profile if the containers within the pods are updated

Yet another object of the embodiments herein is to develop a system and method for generating a framework for predefined policy specification for containerized applications.

Yet another object of the embodiments herein is to develop a system and method for generating a framework for predefined policy specification for k8s orchestrated containers.

Yet another object of the embodiments herein is to develop a system and method for providing a mechanism to keep the static MUD-URL in the container image

Yet another object of the embodiments herein is to develop a system and method for providing a mechanism to scan through existing container images to check for MUD-URL

Yet another object of the embodiments herein is to develop a system and method for pass forwarding the recommended policies from MUD-Server for screening before accepting to apply.

Yet another object of the embodiments herein is to develop a system and method to be used by a security product which provides runtime policy enforcement solution for containerized workloads. Examples of such products/solutions are, Isovalent, Tigera Calico, etc. The runtime policy enforcement solution requires one to provide with the set of policies to enforce.

Yet another object of the embodiments herein is to develop a system and method that is extended to any container runtime platforms such as Dockers, LXC.

Yet another object of the embodiments herein is to develop a system and method to develop a MUD-Profile handler for deployment in-pod or on-node.

Yet another object of the embodiments herein is to develop a system and method generating a container image containing a MUD-URL for which the contents are dynamically fetched using the MUD-Controller or the container image directly containing the MUD-Profile/Policy as a static file, in which case the MUD-Controller directly uses the given MUD-Profile/Policy and thereby eliminating a need for a dynamic fetching of the contents.

Yet another object of the embodiments herein is to develop a system and method to provide Container Security Products that apply policy enforcement on the container operations, thereby alleviating the problems associated with the task of policy discovery.

Yet another object of the embodiments herein is to develop a system and method to provide security products which apply advanced malware protection (AMP)

Yet another object of the embodiments herein is to develop a system and method to provide Framework to extend the concept of MUD based profiles to containerized workloads in k8s-native environment

Yet another object of the embodiments herein is to develop a system and method for detecting MUD-URLs and profiles from the container images during k8s pods startup.

Yet another object of the embodiments herein is to develop a system and method for parameterizing the MUD-Profile so that the final MUD-Profile that gets applied to take into consideration of the container configuration, which is changed depending on the deployment.

These and other objects and advantages of the present invention will become readily apparent from the following detailed description taken in conjunction with the accompanying drawings.

### SUMMARY

This summary is provided to introduce a selection of concepts in a simplified form that are further disclosed in the detailed description. This summary is not intended to determine the scope of the claimed subject matter.

The embodiments herein address the above-recited needs for a system and a method for specifying and managing predefined policies for containerized workloads, also referred to as “containerized applications”, that have specific purposes, specific access patterns, and deployment patterns. According to an embodiment herein, the system and the method disclosed herein extend Manufacturer Usage Description (MUD)-based access control to containerized workloads. The system disclosed herein comprises a policy management interface, a profile handler module, a policy controller module, and a policy server. The profile handler module is operably coupled to a policy enforcement engine for enforcing policies for the containerized workloads. In the method disclosed herein, a user, for example, an application developer, provides a specification of a policy profile defining one or more recommended policies for a containerized application via a policy management interface, associates a link element with the policy profile within a container image of the containerized application, and pushes the policies of the policy profile to the policy server. According to an embodiment herein, the system and the method disclosed herein extend MUD-based profiles to containerized workloads in a Kubernetes® or K8s-native environment. The embodiments herein allow detection of link elements, for example, URLs and associated policy profiles from container images during a K8s pod start-up. The embodiments herein also parameterize policy profiles. The final policy profile that is applied and enforced takes into consideration the container configuration, which may change depending on the deployment.

According to an embodiment herein, a system for specifying and managing pre-defined policies for containerized workloads is provided. The system includes a policy management module for receiving from an application developer, a specification of the policy profile for a containerized application and an associated link element and storing the container image containing the link element associated with the policy profile in a container registry of a policy server. The system also includes a (K8 pod) start-up engine module for auto-detecting if a container contains a uniform resource locator (URL) or a profile. The system also includes profile handler module for detecting and monitoring events of containerized applications. The profile handler module detects a link element associated with the policy profile (URL or profile) by scanning through container images in the container registry, in response to one or more of the events a pod start-up event or a container start-up event. The profile handler module fetches the policy profile of the containerized application associated with the link element from the container registry and transmitting the policy profile to a policy controller module. The system also includes a policy controller module obtaining one or more recommended policies of the policy profile from the policy server or a static file. The policy controller module screens the recommended policies of the policy profile. The policy controller module receives the updates from a security administrator via the policy management interface and updating the recommended policies in accordance with the updates. The policy controller module sends the recommended policies to the profile handler module, wherein the policy controller module communicates with a policy enforcement engine directly to apply the recommended policies and allow or restrict access to and from the containerized application.

According to an embodiment herein, the profile handler module is operably coupled to the policy enforcement engine for enforcing policies for the containerized workloads.

According to an embodiment herein, the policy management module allows the controller to watch for pod/container events and update the policies profile based on such events, and wherein policies are grouped together based on the set of labels which may encompass multiple containers.

According to an embodiment herein, the policy controller module checks if the given container already has an enforced policy based on the recommended set, upon the existence of the enforced policy, the policy controller module ignores corresponding rules and upon non-existence of the enforced policy the policy controller module recommends the corresponding rules to an admin.

According to an embodiment herein, the profile handler module, the policy server, and the policy controller module are programmable using high-level computer programming languages. The policy enforcement engine operates at network level to apply network policies and at applications or systems level to apply system policies.

According to an embodiment herein, an application developer, associates a link element with the policy profile within a container image of the containerized application, and pushes the policies of the policy profile to the policy server.

According to an embodiment herein, the policy management interface allows the user to upload a static URL as part of the container image.

According to an embodiment herein, a method for specifying and managing predefined policies for containerized workloads is provided. The method includes an application developer providing a specification of the policy profile for a containerized application and an associated link element via a policy management interface and storing the container image containing the link element associated with the policy profile in a container registry. The method further includes detecting and monitoring using a profile handler module, events of containerized applications. The method further includes detecting by the profile handler module, a link element associated with the policy profile by scanning through container images in the container registry, in response to one or more of the events a pod start-up event or a container start-up event. The method further includes fetching using profile handler module, the policy profile of the containerized application associated with the link element from the container registry and transmitting the policy profile to a policy controller module. The method further includes obtaining using the policy controller module one or more recommended policies of the policy profile from the policy server or astatic file. The method further includes screening using the policy controller module, of the recommended policies of the policy profile. The method further includes receiving by the policy controller module, the updates from the security administrator via the policy management interface and updates the recommended policies in accordance with the updates. The method further includes sending by the policy controller module, the recommended policies to the profile handler module. The policy controller module communicates with the policy enforcement engine directly to apply the recommended policies and allow or restrict access to and from the containerized application.

According to an embodiment herein, the link element is a static file containing the policy profile, the policy controller module directly processes the recommended policies from the policy profile without having to dynamically fetch the recommended policies from the policy server.

According to an embodiment herein, the link element is a static Uniform Resource Locator (URL), the policy controller module, in communication with the profile handler module, fetches the recommended policies of the fetched policy profile from the policy server.

According to an embodiment herein, the policy controller module bypasses the profile handler module and directly communicates with the policy enforcement engine for enforcement of the recommended policies.

According to an embodiment herein, the container image contains a link element, a URL for which the contents are dynamically fetched from the policy server using the policy controller module.

According to an embodiment herein, the URL is resolved at runtime to fetch the policy from a remote repo.

According to an embodiment herein, the policy is directly placed inside the container image as a static file.

According to an embodiment herein, the security administrator chooses to modify or add additional rule sets to the policy and subsequently accepts the policy in context to the container/pod.

According to an embodiment herein, the profile handler module is an on-node process/daemon configured to communicate with the policy controller module to fetch the policies.

In yet another aspect, one or more non-transitory computer readable storage mediums storing one or more sequences of instructions, which when executed by one or more processors, causes a method for specifying and managing predefined policies for containerized workloads is provided. The method includes an application developer providing a specification of the policy profile for a containerized application and an associated link element via a policy management interface and storing the container image containing the link element associated with the policy profile in a container registry. The method further includes detecting and monitoring by a profile handler module, events of containerized applications. The method further includes detecting by the profile handler module, a link element associated with the policy profile by scanning through container images in the container registry, in response to one or more of the events a pod start-up event or a container start-up event. The method further includes fetching by profile handler module, the policy profile of the containerized application associated with the link element from the container registry and transmitting the policy profile to a policy controller module. The method further includes obtaining by the policy controller module one or more recommended policies of the policy profile from the policy server or astatic file. The method further includes screening by the policy controller module, of the recommended policies of the policy profile. The method further includes receiving by the policy controller module, the updates from the security administrator via the policy management interface and updates the recommended policies in accordance with the updates. The method further includes sending by the policy controller module, the recommended policies to the profile handler module. The policy controller module communicates with the policy enforcement engine directly to apply the recommended policies and allow or restrict access to and from the containerized application.

According to an embodiment herein, the link element is a static file containing the policy profile, the policy controller module directly processes the recommended policies from the policy profile without having to dynamically fetch the recommended policies from the policy server.

According to an embodiment herein, the link element is a static Uniform Resource Locator (URL), the policy controller module, in communication with the profile handler module, fetches the recommended policies of the fetched policy profile from the policy server.

According to an embodiment herein, the policy controller module bypasses the profile handler module and directly communicates with the policy enforcement engine for enforcement of the recommended policies.

According to an embodiment herein, the container image contains a link element, a URL for which the contents are dynamically fetched from the policy server using the policy controller module.

According to an embodiment herein, the URL is resolved at runtime to fetch the policy from a remote repo.

According to an embodiment herein, the policy is directly placed inside the container image as a static file.

According to an embodiment herein, the security administrator chooses to modify or add additional rule sets to the policy and subsequently accepts the policy in context to the container/pod.

According to an embodiment herein, the profile handler module is an on-node process/daemon configured to communicate with the policy controller module to fetch the policies.

According to one or more embodiments herein, the related systems comprise circuitry and/or programming for executing the methods disclosed herein. The circuitry and/or programming are of any combination of hardware, software, and/or firmware configured to execute the methods disclosed herein depending upon the design choices of a system designer. According to an embodiment herein, various structural elements are employed depending on the design choices of the system designer.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

The foregoing summary, as well as the following detailed description, is better understood when read in conjunction with the appended drawings. For illustrating the embodiments herein, exemplary constructions of the embodiments are shown in the drawings. However, the embodiments herein are not limited to the specific components and methods disclosed herein. The description of a component or a method step referenced by a numeral in a drawing is applicable to the description of that component or method step shown by that same numeral in any subsequent drawing herein.

FIG. 1 illustrates a block diagram representation of a system for specifying and managing predefined policies for containerized workloads, according to an embodiment herein.

FIG. 2 illustrates a block diagram of an exemplary implementation of the system of FIG. 1 for specifying and managing predefined policies for containerized workloads, according to an embodiment herein.

FIG. 3 illustrates a process flow diagram explaining/indicating the steps performed by a profile handler module of the system for managing predefined policies for containerized workloads, according to an embodiment herein.

FIG. 4 exemplarily illustrates a software code executed by the profile handier module for monitoring pod events and searching for a link element associated with a policy profile, according to an embodiment herein.

FIGS. 5A-5C illustrate flow diagrams indicating the methods for registering, fetching, and applying a policy profile associated with a link element, according to an embodiment herein.

FIGS. 6A-6B exemplarily illustrate a sample policy profile specified via a policy management interface, according to an embodiment herein,

FIG. 7 exemplarily illustrates a sample link element associated with a policy profile and uploaded as part of a container image, according to an embodiment herein.

FIGS. 8A-8B illustrate a process flow diagram explaining/indicating a method for specifying and managing pre-defined policies for containerized workloads, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The various embodiments disclosed herein provide methods and systems for and managing predefined policies for containerized workloads also referred to as “containerized applications”. According to an embodiment herein, the system and method of the present technology implements manufacturer usage description (MUD)-based access control or policy controls for containerized workloads. For purposes of illustration, the detailed description refers to an MUD-based implementation for specifying and managing predefined policies for containerized workloads; however, the scope of the method and the system disclosed herein is not limited to an MUD-based implementation but may be extended to include implementations of other embedded software standard specifications for policy formats. The present technology provides a framework for predefined policy specification for containerized workloads or containerized applications by allowing users, for example, application developers, to provide the policy specification. In the present technology, a user, for example, an application developer provides a specification of a policy profile defining one or more recommended policies for a containerized application via a policy management interface/framework, associates a link element with the policy profile within a container image of the containerized application, and pushes the policies of the policy profile to the policy server.

According to an embodiment herein, the link element is a static Uniform Resource Locator (URL) that links to the policy profile. The method disclosed herein provides a mechanism for maintaining the static URL in the container image. The system includes a policy management module (or interface) that allows the user to upload the static URL as part of the container image. In another embodiment, the link element is a static file containing the policy profile. The system disclosed herein receives the specification of the policy profile for the containerized application and the associated link element within the container image of the containerized application via the policy management interface and stores the container image containing the link element associated with the policy profile in a container registry. According to an embodiment herein the system stores the recommended policies of the policy profile of the containerized application. The system of the present technology monitors and detects events of containerized applications. According to an embodiment herein, in response to one or more of the events, for example, a pod start-up event or a container start-up event, the profile handler module detects the link element associated with the policy profile by scanning through container images in the container registry. The present technology provides a mechanism for scanning through existing container images to check for the static URL. The system of the present technology fetches the policy profile of the containerized application associated with the link element from the container registry and transmits the policy profile to the policy controller module. According to an embodiment herein, system facilitates screening of the recommended policies of the policy profile. For example, the policy controller module passes the recommended policies from the policy server for screening via the policy management interface before accepting the recommended policies for application through the policy enforcement engine. The system receives updates, if any, to the recommended policies of the policy profile from a security administrator via the policy management interface. The system facilitates execution of the recommended policies of the policy profile for the containerized application. According to an embodiment herein, the system applies the recommended policies and allows or restricts access to and from the containerized application. The system disclosed herein receives the specification of the policy profile for the containerized application and the associated link element via the policy management interface and stores the container image containing the link element associated with the policy profile in a container registry. According to an embodiment herein where the link element is a static URL that links to the policy profile, the policy server stores the recommended policies of the policy profile of the containerized application.

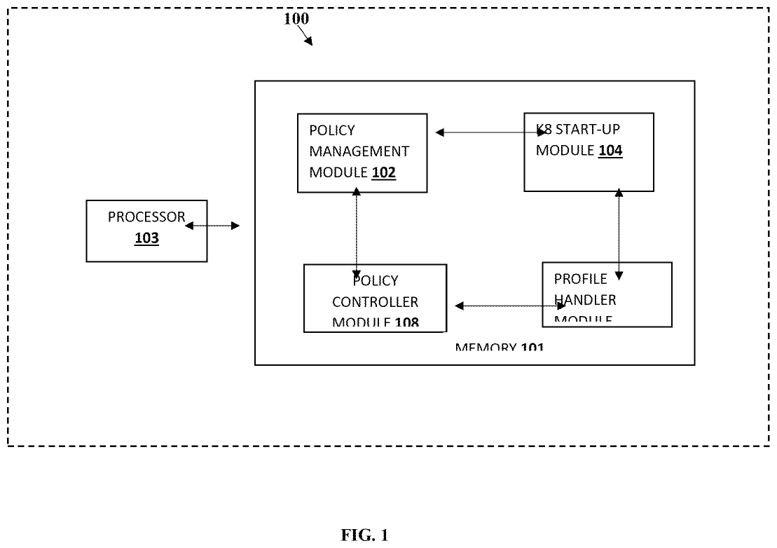

FIG. 1 illustrates a block diagram representation of a system 100 for specifying and managing predefined policies for containerized workloads, according to an embodiment herein. The system 100 includes a memory 101 for storing one or more executable modules and a processor 103 operatively coupled to the memory 101 and configure to execute the one or more executable modules for specifying and managing predefined policies for containerized workloads. The one or more executable modules comprises a policy management module 102, a (K8 pod) start-up engine module 104, a profile handler module 106, and a policy controller module 108, operatively coupled with one another and with a policy server (not shown) via for example a communication network. Examples of the communication network may include, but are not limited to, a Wireless Fidelity (Wi-Fi) network, a Local Area Network (LAN), a wireless personal area network (WPAN), a Wireless Local Area Network (WLAN), a wireless wide area network (WWAN), a cloud network, a cellular network, a Metropolitan Area Network (MAN), a software defined wide area network (SD-WAN), or the Internet, and the like. According to an embodiment herein, the policy management module 102, the (K8 pod) start-up engine 104, the profile handler module 106, and the policy controller module 108 constitute processor executable modules stored in a memory (not shown) of a computer. According to an embodiment herein, the policy management module 102 is configured for receiving from an application developer, a specification of the policy profile for a containerized application and an associated link element and storing the container image containing the link element associated with the policy profile in a container registry of the policy server. The policy management module (policy management interface or interface) 102 allows a user to upload a static URL as part of the container image. The policy management module 102 allows the controller to watch for pod/container events and update the policies profile based on such events. The policies (K8 access policies) are grouped together based on the set of labels which may encompass multiple containers.

The (K8 pod) start-up engine 104 auto-detects if a container contains a uniform resource locator (URL) or a profile. According to an embodiment herein the URL is MUD URL. The profile handler module 106 monitors and detects events of containerized applications. According to an embodiment herein, in response to one or more of the events, for example, a pod start-up event or a container start-up event, the profile handler module 106 detects the link element associated with the policy profile by scanning through container images in the container registry. The profile handler module 106 fetches the policy profile of the containerized application associated with the link element from the container registry and transmits the policy profile to the policy controller module 108. The policy controller module 108 obtains the recommended policies of the policy profile from the policy server or the static file. According to an embodiment herein the link element is a URL, the policy controller module 108, in communication with the profile handler module 106, fetches the recommended policies of the fetched policy profile from the policy server. In another embodiment where the link element is a static file containing the policy profile, the policy controller module 108 directly processes the recommended policies from the policy profile without having to dynamically fetch the recommended policies from the policy server. According to an embodiment herein, an application developer, associates a link element with the policy profile within a container image of the containerized application, and pushes the policies of the policy profile to the policy server. According to an embodiment herein, the policy controller module 108 checks if the given container already has an enforced policy based on the recommended set, upon the existence of the enforced policy, the policy controller module ignores corresponding rules and upon non-existence of the enforced policy the policy controller module recommends the corresponding rules to an admin.

According to an embodiment herein, the policy controller module 108 screens the recommended policies of the policy profile. For example, the policy controller module receives updates, if any, to the recommended policies of the policy profile from a security administrator via the policy management interface. The security administrator may modify or add additional rule sets to the recommended policies via the policy management interface and subsequently apply the recommended policies in context to the containerized application. The policy controller module 108 receives the updates from the security administrator via the policy management interface and updates the recommended policies in accordance with the updates. The policy controller module 108 sends the recommended policies to the profile handler module. The policy controller module 108 communicates with a policy enforcement engine directly to apply the recommended policies and allow or restrict access to and from the containerized application.

The profile handler module 106, in communication with the policy enforcement engine, facilitates execution of the recommended policies of the policy profile for the containerized application. According to an embodiment herein, the policy controller module 108 communicates with the policy enforcement engine directly to apply the recommended policies and allow or restrict access to and from the containerized application. In this embodiment, the policy controller module 108 bypasses the profile handler module and directly communicates with the policy enforcement engine for enforcement of the recommended policies. According to an embodiment herein, the profile handler module 106 is operably coupled to the policy enforcement engine for enforcing policies for the containerized workloads.

According to an embodiment herein, the profile handler module 106, the policy server, and the policy controller module 108 are programmable using high-level computer programming languages and the policy enforcement engine operates at network level to apply network policies and at applications level or systems level to apply system policies.

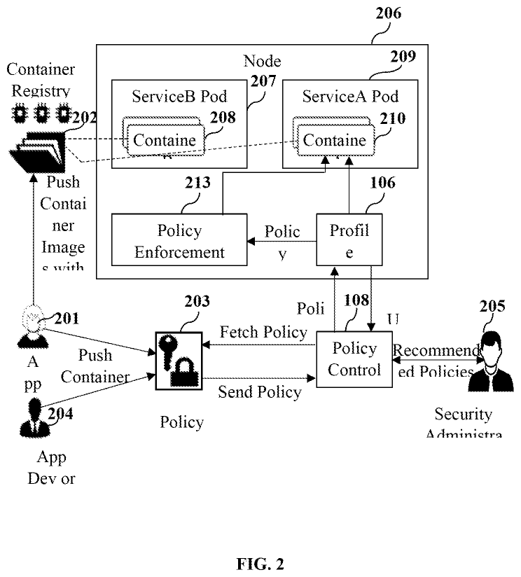

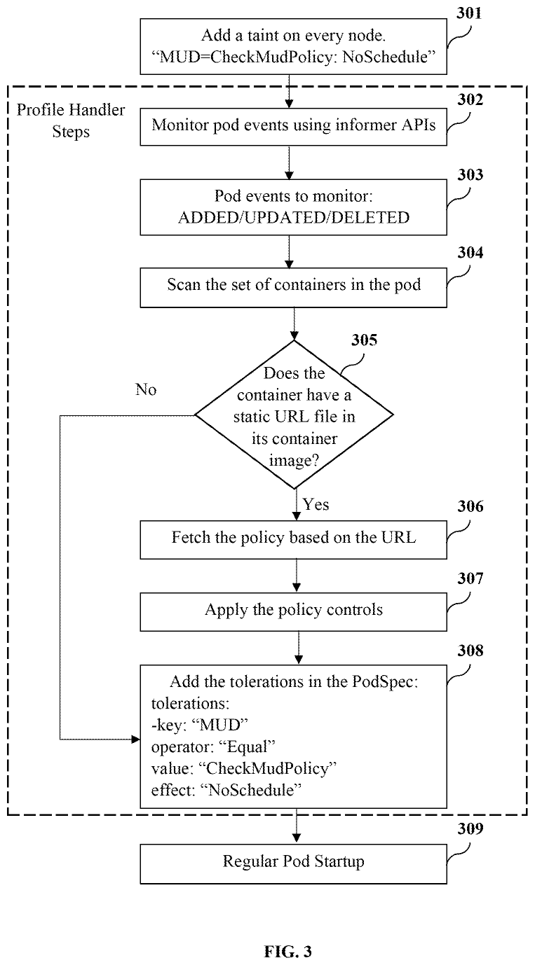

FIG. 2 illustrates a block diagram of an exemplary implementation of the system 100 of FIG. 1 for specifying and managing predefined policies for containerized workloads, according to an embodiment herein. In an exemplary implementation, the system 100 disclosed herein provides a framework for predefined policy specification for containerized workloads or containerized applications operating in a Kubernetes® or K8s container-orchestration platform comprising K8s orchestrated containers. The framework, for example, a K8s-native framework (used interchangeably with the term policy management module 102), allows an application developer, for example, a container-application developer 201, to host a policy profile and point to the policy profile using a static URL. According to an embodiment herein, the policy profile is similar to a Manufacturer Usage Description (MUD) profile referenced by an MUD-URL. The framework allows the container-application developer 201 to specify a set of recommended policies for a containerized application. According to an embodiment herein, the framework 102 allows the container-application developer 201 to specify the policy profile with the policies directly as a file as part of a container. In another embodiment, the framework 102 allows the container-application developer 201 to specify the URL through which the policy profile is retrievable dynamically from a container registry 202, which allows the policies of the policy profile to be retrieved dynamically from the policy server 203. According to an embodiment herein, the policy server 203 is managed by a manufacturer. In another embodiment, the policy server 203 is a global repository. The framework 102 specifies methods as part of the profile handler module 106 to detect a policy profile in a K8s-native orchestration environment. The profile handler module 106 is configured to scan through all the containers or the container images in the container registry 202 to fetch the policy profiles as disclosed in the detailed description of FIG. 3. In this exemplarily implementation, K8s allows the profile handler module 106 to monitor pod/container events and update the policy profiles based on such events. According to an embodiment herein, K8s access policies are grouped together based on a set of labels which may encompass multiple containers. K8s requires the policies to be specified in the context of labels. A container has one or more labels. Any container matching the set of labels specified in the context of a policy gets that policy applied on that container. For example, consider the following code snippet:

```
apiVersion: security.accuknox.com/v1
kind: KubeArmorPolicy
metadata:
  name: ksp-mysql-dir-audit
  namespace: wordpress-mysql
spec:
  selector:
    matchLabels:
      app: mysql
  network:
    listenonly:
    - port: MYSQL_SERVER_PORT
    - protocol: tcp
  action:
    Audit
```

In the above example, “app: mysql” is a selector label in context to the policy. Any container in the deployment having the label “app: mysql” get the policy applied. Labels are used by K8s to group multiple containers/pods together. The policy controller module 108 checks whether a given container already has an enforced policy based on the recommended rule set. If the given container already has an enforced policy based on the recommended rule set, the policy controller module 108 is configured to ignore the corresponding rules. If the given container does not have an enforced policy based on the recommended rule set, the policy controller module 108 is configured to recommend the corresponding rules to a security administrator 205 via the policy management interface 102.

In the exemplary implementation illustrated in FIG. 2, the system 100 disclosed herein comprises the container registry 202, the profile handler module 106, the policy server 203, and the policy controller module 108. The container registry 202 is configured to store multiple container images of containerized applications. According to an embodiment herein, the profile handler module 106 is operably coupled to the policy enforcement engine 213 within a node 206 in the K8s-native orchestration environment and to the policy controller module 108 outside the node 206. According to an embodiment herein, the profile handler module 106 is configured to be deployed in-pod or on-node. The profile handler module 106 and the policy enforcement engine 213 are in operable communication with the containers, for example, ContainerA 210 in ServiceA pod 209 and ContainerB 208 in ServiceB pod 207 of the node 206. According to an embodiment herein, the policy controller module 108 is located within a control plane of the containerized application. In another embodiment, the policy controller module 108 is deployed in-pod or in-node. To execute the method disclosed herein, consider an example where a container-application developer 201 creates a container image with the link element, for example, the URL, associated with a policy profile defining one or more policies as part of the base container image, via the policy management interface provided by the framework of the system 100. In this example, the container-application developer 201 pushes or updates the policies of the policy profile in context to the URL to the policy server 203. According to an embodiment herein, the system 100 allows the container-application developer 201 to create and update the policies of the policy profile. In another embodiment, the system 100 allows other users associated with development, security, and operations (DevSecOps), for example, DevSecOps community members 204, to update the policies of the policy profile and store the updated polices in the policy server 203.

After the containers, for example, ContainerA 210 and ContainerB 208, are deployed in the K8s pods, for example, ServiceA pod 209 and ServiceB pod 207 respectively, during the container start-up, the profile handler module 106 monitors for a container start-up event and checks whether there is any container with a policy profile. Consider an example where the profile handler module 106 monitors and detects a startup event of ContainerA 210, for which a policy profile defining a policy with rules was specified by the container-application developer 201. In response to the start-up event of ContainerA 210, the profile handler module 106 pulls the URL associated with the policy profile for Container A 210 from the container registry 202. The profile handler module 106 communicates the policy profile to the policy controller module 108 in context to the URL. The policy controller module 108 fetches the policy of the policy profile linked to the URL from the policy server 203. According to an embodiment herein, the policy controller module 108 sends the fetched policy to a screener, for example, a security administrator 205, to be reviewed. The security administrator 205 may choose to edit the policy. On receiving the edited policy, the policy controller module 108 accepts and sends the edited policy to the policy enforcement engine 213 for enforcement. According to an embodiment herein, the policy controller module 108 directly accepts and sends the fetched policy to the policy enforcement engine 213 for enforcement. In another embodiment, the policy controller module 108 accepts and sends the policy to the policy enforcement engine 213 for enforcement via the profile handler module 106 as exemplarily illustrated in FIG. 2. The policy enforcement engine 213 enforces the policy in context to the container, for example, ContainerA 210.

According to an embodiment herein, each of the components of the system 100 disclosed herein, for example, the profile handler module 106, the policy server 203, and the policy controller module 108 are programmable using high-level computer programming languages. The system 100 disclosed herein comprises multiple processors and non-transitory, computer-readable storage media, for example, memory units, across the framework for storing computer program instructions defined by the components, for example, for example, the profile handler module 106, the policy server 203, and the policy controller module 108 of the system 100. The processors are operably and communicatively coupled to the memory units for executing the computer program instructions defined by the components, for example, the profile handler module 106, the policy server 203, and the policy controller module 108 of the system 100. The processors refer to any one or more microprocessors, central processing unit (CPU) devices, finite state machines, computers, microcontrollers, digital signal processors, logic, a logic device, an application specific integrated circuit (ASIC), a field-programmable gate array (FPGA), a chip, etc., or any combination thereof, capable of executing computer programs or a series of commands, instructions, or state transitions. The system 100 disclosed herein is not limited to employing processors. According to an embodiment herein, the system 100 employs one or more controllers or microcontrollers. According to an embodiment herein, the profile handler module 106, the policy server 203, and the policy controller module 108 of the system 100, each defines computer program instructions, which when executed by respective processors, cause the processors to specify and manage predefined policies for containerized workloads. The processors retrieve instructions defined by the profile handler module 106, the policy server 203, and the policy controller module 108 of the system 100 from respective memory units for executing respective functions disclosed above.

FIG. 3 illustrates a flowchart comprising steps performed by the profile handler module of the system for managing policies for containerized workloads, according to an embodiment herein. The K8s orchestration engine provides primitives to handle pod events, for example, pod create, delete, and update events. The taints and tolerations mechanism implemented by the K8s orchestration engine allows the K8s orchestration engine to select the pods that may be started on a node. The pods do not start unless the taints mentioned by the node are satisfied as part of PodSpec tolerations, where PodSpec refers to a pod library comprising specifications and details about where the source should be fetched from, what files to use, what build settings to apply, and other general metadata such as name, version, and description. The profile handler module 106 uses the taints and tolerations mechanism to defer a pod start-up until a policy profile is fetched and applied. The profile handler module 106, in operable communication with the K8s orchestration engine, implements automatic detection (auto-detection) of policy profiles and URLs for containers. The K8s orchestration engine allows monitoring of pod add, modify, and delete events. The profile handler module 106 waits for these events. Any update in the containers results in an event sent to the profile handler module which skims through the link element, for example, the URL, associated with a policy profile and updates the policy of the policy profile from the policy server 203. The K8s orchestration engine or pod start-up engine allows the profile handler module to detect whether a container contains a URL or a policy profile. The profile handler module 106 is configured to scan for the URL or a policy profile in a container image on pod start-up. The steps involved in scanning through pods and identifying a set of container images for which the URL is searched are illustrated in FIG. 3. The process flow illustrated in FIG. 3 comprises container initiation discovery and a search for the URL within containers. The URL will be resolved at runtime to fetch the policy of the policy profile from the policy server 203. According to an embodiment herein, the policy is directly placed inside the container image as a static file as disclosed in the detailed description of FIGS. 1-2.

If the container is orchestrated using the K8s orchestration engine, then the use of pod based K8s events to check for pod start-ups is illustrated in FIG. 3. The pod YAML contains the details of all the containers within. An example of wordpress-mysql pod yaml details containing internal container details is disclosed below. If the container is orchestrated without K8s, then docker/container runtime engine interfaces are implemented for detecting initiation of new containers.

```
Name: mysql-75fd64d55-fdrg7
Namespace: wordpress-mysql
Priority: 0
Node: vbox/192.168.0.102
Start Time: Thu, 21 Jan 2021 15:49:56 +0000
Labels: app=mysql
    pod-template-hash=75fd64d55
Annotations: container.apparmor.security.beta.kubernetes.io/mysql: localhost/appar-
mor-mysql
Status: Running
IP: 10.0.0.20
IPs:
  IP: 10.0.0.20
Controlled By: Replica-Set/mysql75fd64d55
  Containers:
    mysql:
      Container ID:
  docker://6f0beb198764011a0b9bflc4a653489c3c94dcd30fe58e0d39d8d073984
  5583b
      Image: mysql:5.6
      Image ID: docker-
  pulla-
  ble://mysql@sha256:a1868bd2d1c8c32a46baa7d06f38c3de76e949c8f811a5bc4
  2bac6738520f3a7
      Port: 3306/TCP
      Host Port: 0/TCP
      State: Waiting
        Reason: CrashLoopBackOff
      Last State: Terminated
        Reason: Error
        Exit Code: 1
        Started: Mon, 25 Jan 2021 19:17:37 +0000
        Finished: Mon, 25 Jan 2021 19:17:37 +0000
      Ready: False
      Restart Count: 13
      Environment:
        MYSQL_ROOT_PASSWORD: root-password
      Mounts:
        /var/run/secrets/kubernetes.io/serviceaccount from default-token-55lbs (ro)
  Conditions:
    Type Status
    Initialized True
    Ready False
    ContainersReady False
    PodScheduled True
  Volumes:
    default-token-55lbs:
      Type: Secret (a volume populated by a Secret)
      SecretName: default-token-55lbs
      Optional: false
  QoS Class: BestEffort
  Node-Selectors: <none>
  Tolerations: node.kubernetes.io/not-ready: NoExecute op=Exists for 300s
          node.kubernetes.io/unreachable: NoExecute op=Exists for 300s
```

Every container has an associated container image which is a file system containing a set of process files, configuration files, and other internal files for that container. The base path of that container or any other predefined path may contain a static URL file containing the URL to be fetched. As illustrated in FIG. 3, According to an embodiment herein, the K8s orchestration engine adds 301 a taint, for example, “MUD=CheckMudPolicy: NoSchedule” on every node. The profile handler module 106 monitors 302 pod events using K8s informer Application Programming Interfaces (APIs). The profile handler module 106 monitors for pod events, for example, added, updated, and deleted events 303. The profile handler module 106 scans 304 the set of containers in the pod. The profile handler module 106 determines 305 whether the container has a static URL file in its container image. If the container has a static URL file in its container image, the profile handler module 106, in communication with the policy controller module, fetches 306 the policy based on the URL from the policy server 203. The profile handler module 106, in communication with the policy enforcement engine, applies 307 the policy controls and proceeds to step 308. If the container does not have a static URL file in its container image, the profile handler module 106 adds 308 tolerations, for example: key: “MUD”, operator: “Equal”; value: “CheckMudPolicy”, and effect: “NoSchedule”, in the PodSpec. The K8s orchestration engine then proceeds to perform a regular pod start-up 309.

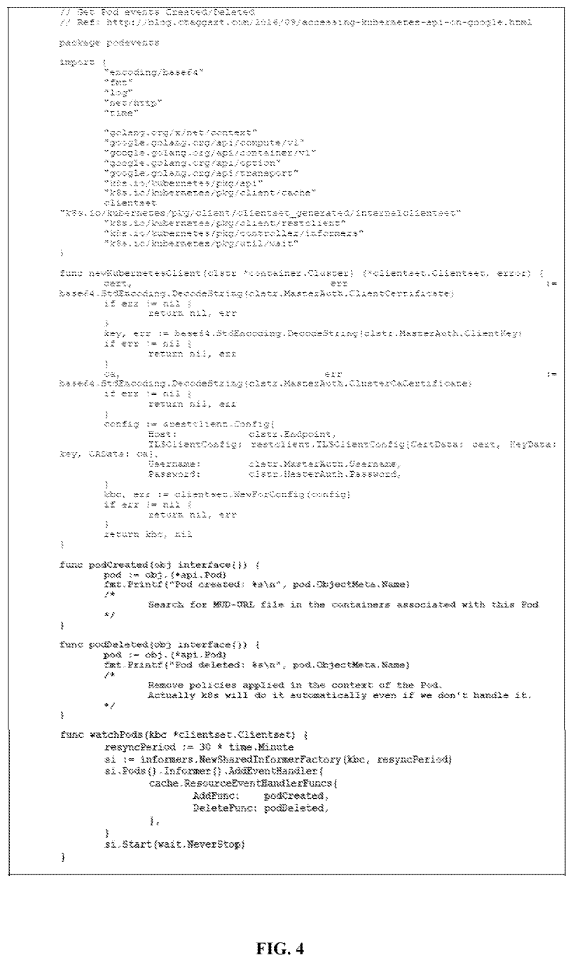

FIG. 4 exemplarily illustrates a software code executed by the profile handler module 106 for monitoring pod events and searching for a link element, for example, a URL, associated with a policy profile, according to an embodiment herein. The software code discloses how to use the K8s Application Programming Interfaces (APIs) to obtain the pod events and at what point to start searching for the URL.

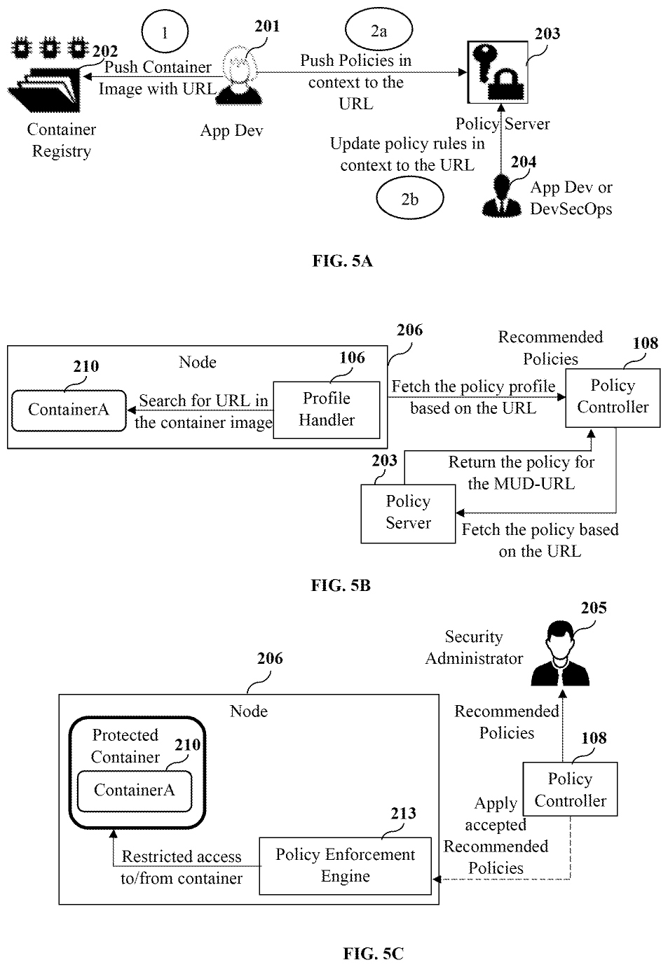

FIGS. 5A-5C illustrate flow diagrams showing methods for registering, fetching, and applying a policy profile associated with a link element, according to an embodiment herein. According to an embodiment herein, the method disclosed herein comprises three phases, namely, a policy profile registration phase as illustrated in FIG. 5A, a URL detection and profile fetch phase as illustrated in FIG. 5B, and a policy application phase as illustrated in FIG. 5C. In the policy profile registration phase illustrated in FIG. 5A, the framework of the system disclosed herein allows application developers 201 to host their policy profiles as part of container images. In the policy profile registration phase, an application developer 201 registers a policy profile in context to a container 210 in a node 206 and creates a static URL within the container image for the policy profile, for example, via the policy management interface provided by the framework. The application developer 201 pushes the container image containing the URL to the container registry 202. The application developer 201 adds or pushes policies for the policy profile in context to the URL to the policy server 203. According to an embodiment herein, the application developer 201 adds or pushes a first set of policies in context of the URL to the policy server 203. The framework allows the application developer 201 to affix a relation between the URL and the policies since the framework provides control to the application developer 201 to push the container image to the container registry 202. According to an embodiment herein, the framework allows external parties, for example, DevSecOps community members 204 or other community members, to request updates to policy rules after review from an application developer team, similar to a procedure for updating code using a version control system. The updated policy rules in context to the URL are stored in the policy server 203. According to an embodiment herein, the framework allows parameterization of the policy. The policy comprises a listing of rules, for example, allow ingress access to port 80. The framework 102 parameterizes the port and other specifications that may depend on the container configuration. The framework 102 allows automatic updating of the policy profile if the containers within the pods are updated.

In the URL detection and profile fetch phase as illustrated in FIG. 5B, on pod/container start-up, the K8s orchestration engine notifies the profile handler module 106 that monitors start-up events, thereby allowing the profile handler module 106 to start the procedure of URL detection and profile fetch. The profile handler module 106 searches for the URL in the container image. The profile handler module 106 then fetches the policy profile based on the URL and sends the policy profile to the policy controller module 108. According to an embodiment herein, the policy controller module 108 fetches the policy of the policy profile based on the URL from the policy server 203. The policy server 203 returns the policy for the URL to the policy controller module 108. The policy controller module 108 fetches the policies on behalf of the pods. The profile handler module 106 is an on-node process/daemon configured to communicate with the policy controller module 108 to fetch the policies. The policy controller module 108 acts as a proxy configured to handle fetch requests on behalf of the profile handler module 106 across all the nodes in a K8s cluster; apply policy transformation; and pass on the policies to a user as a recommended set.

Consider an example where a mysqlserver-container is deployed. The policy fetched by the policy controller module 108 from the policy server 203 is a generic policy as exemplarily disclosed below.

```
apiVersion: security. accuknox.com/v1
kind: KubeArmorPolicy
metadata:
  name: ksp-mysql-dir-audit
  namespace: wordpress-mysql
spec:
  selector:
    matchLabels:
      app: mysql
  network:
    listenonly:
    - port: MYSQL_SERVER_PORT
    - protocol: tcp
  action:
    Audit
```

The policy controller module 108 considers deployment specific changes to the above policy and causes the policy to undergo deployment specific updates. In the above example, the policy stored in the policy server 203 controls ingress access to the mysqlserver-container only through TCP port 3306, which is the default mysql server listening port. However, a deployment may have used a different mysql server listening port for different reasons. The policy fetched from the policy server 203, therefore, has a generic representation of the server port value, for example, MYSQL_SERVER_PORT. The server port value MYSQL_SERVER_PORT may be a configuration that is deployment specific. The final policy would have to take into consideration the container configuration which may depend on the deployment. The policy controller module 108 updates this configuration value on fetching the policy from the policy server 203 but before sending the recommendations to the user. The policy controller module 108 executes a transformation of the above policy as exemplarily disclosed below:

```
apiVersion: security:accuknox.com/v1
kind: KubeArmorPolicy
metadata:
  name: ksp-mysql-dir-audit
  namespace: wordpress-mysql
spec:
  selector:
    matchLabels:
      app: mysql
  network:
    listenonly:
    - port: 3306
    - protocol: tcp
  action:
    Audit
```

In the policy application phase as illustrated in FIG. 5C, the policy controller module 108 renders the policy containing a recommended policy rule set returned by the policy server 203 to the security administrator 205, for example, via the policy management interface. The security administrator 205 may choose to modify or add additional rule sets to the policy and subsequently accept the policy in context to the container/pod. The policy controller module 108 receives the accepted policy from the security administrator 205 via the policy management interface and According to an embodiment herein, sends the accepted policy to the policy enforcement engine 213 for application to the container 210 in the node 206. In another embodiment, the policy controller module 108 sends the accepted policy to the policy enforcement engine 213 via the profile handler module 106 as disclosed in the detailed description of FIG. 2. The policy apply operation is idempotent in nature. The policy enforcement engine 213 enforces the accepted policy in context to the container 210, thereby allowing or restricting access to and from the container 210 in accordance with the accepted policy.

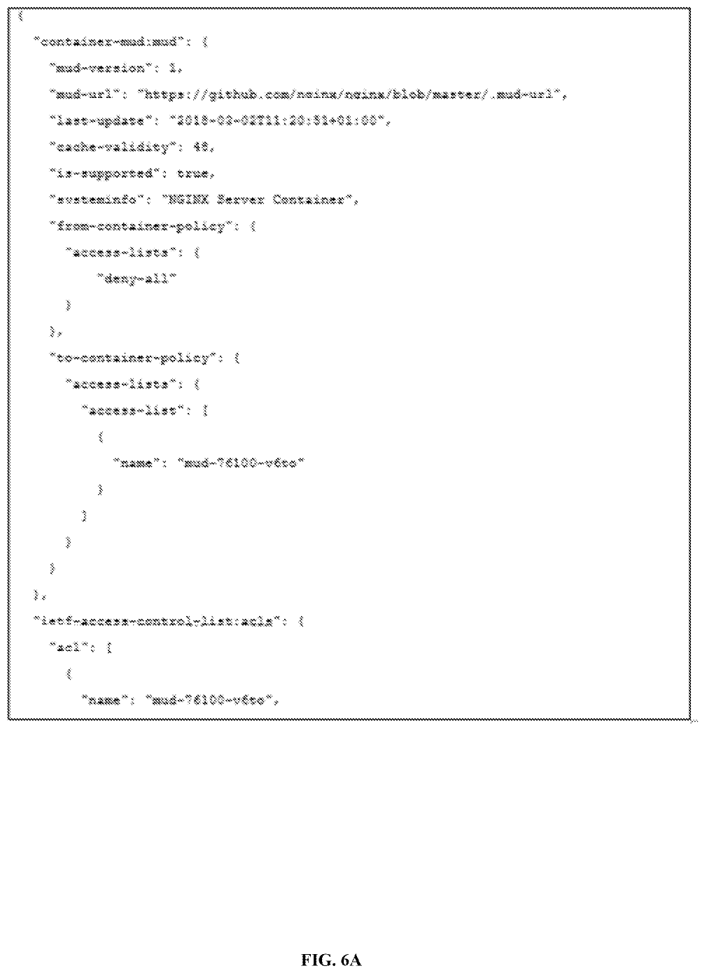

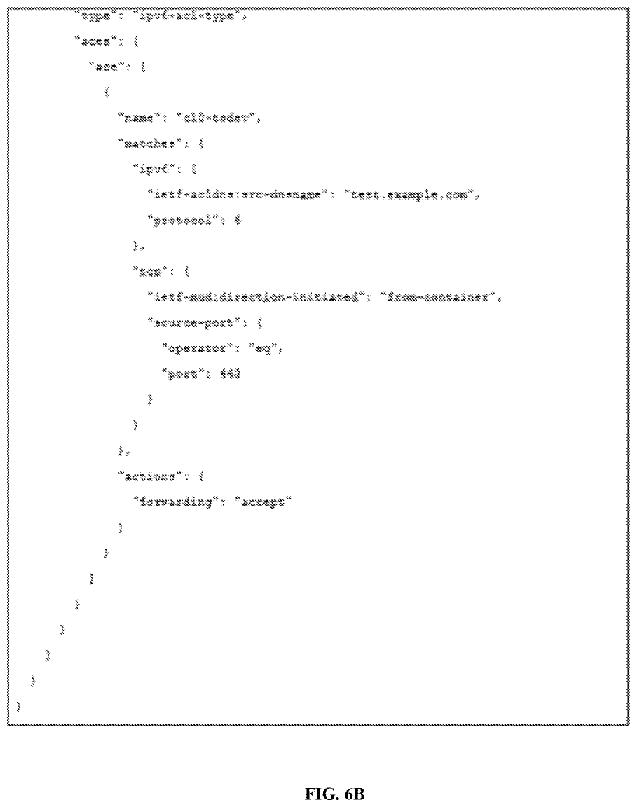

FIGS. 6A-6B exemplarily illustrate a sample policy profile specified via a policy management interface 102, according to an embodiment herein. The system disclosed herein allows a user to create a policy profile as exemplarily illustrated in FIGS. 6A-6B. The policy profile is associated with a link element, for example, a URL such as “https://github.com/nginx/nginx/blob/master/.mud-url” as illustrated in FIG. 6A. The profile handler module 106 uploads the policy profile as part of a container image, for example, NGINX® server docker container image.

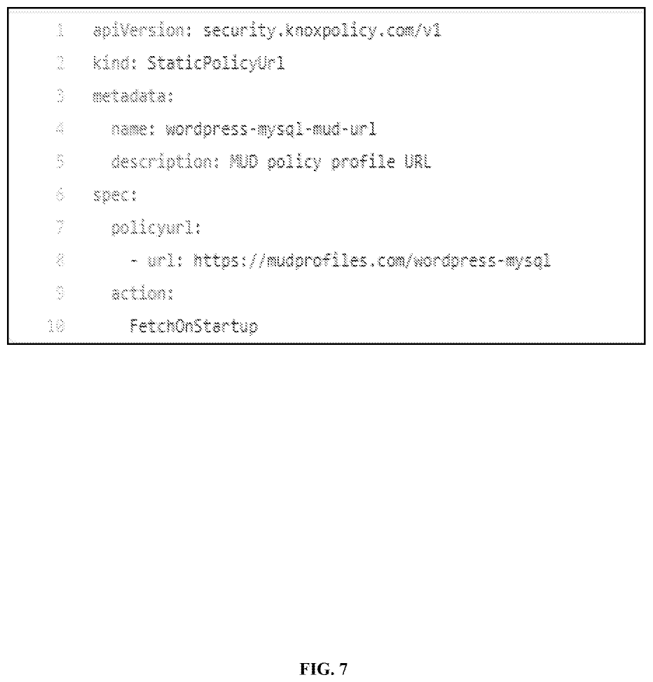

FIG. 7 exemplarily illustrates a sample link element associated with a policy profile and uploaded as part of a container image, according to an embodiment herein. According to an embodiment herein, the container image contains a link element, for example, a URL for which the contents are dynamically fetched from the policy server 203 using the policy controller module 108. In another embodiment, the container image directly contains the policy of the policy profile as a static file, in which case the policy controller module 108 directly uses the given policy without executing a dynamic fetch procedure. In another embodiment, the profile handler module 106 auto-populates the URL without changing the existing containers. For example, for NGINX® pods, the profile handler module 106 is configured to check the NGINX containers and based on the NGINX configuration, auto-generate a manufacturer usage description (MUD)-URL.

According to an embodiment herein, on pod start-up, the pod uses a Dynamic Host Configuration Protocol (DHCP) to obtain an Internet Protocol (IP) address from a Container Network Interface (CNI). The profile handler module 106 checks through all the containers for a specific file containing, for example, an MUD context and uses the MUD context to populate the DHCP request with an MUD-URL. In another embodiment, instead of using DHCP, the profile handler module 106 inspects for a MUD-URL file in a base folder of the container image. The framework 102 of the system 100 disclosed herein allows auto-detection of MUD-URLs from containers and fetching of policy details according to the MUD-URLs.

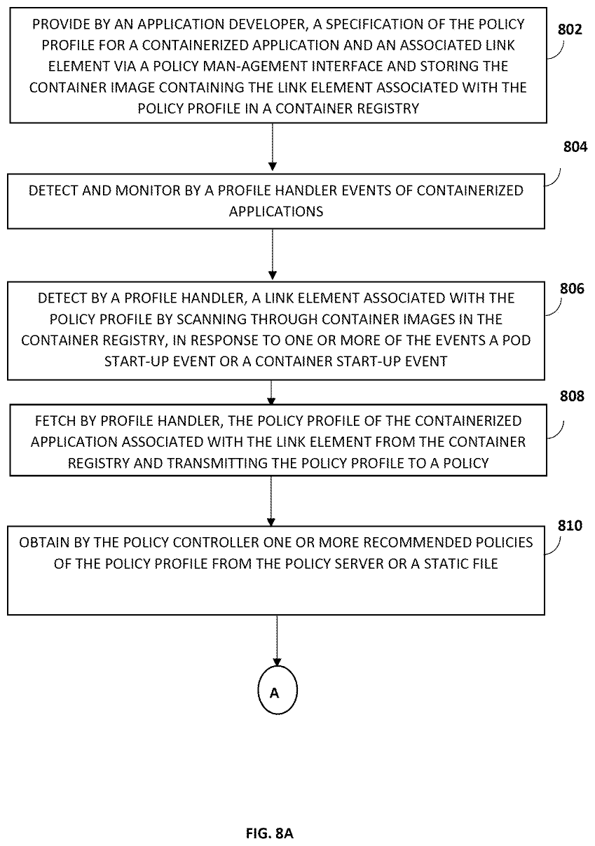

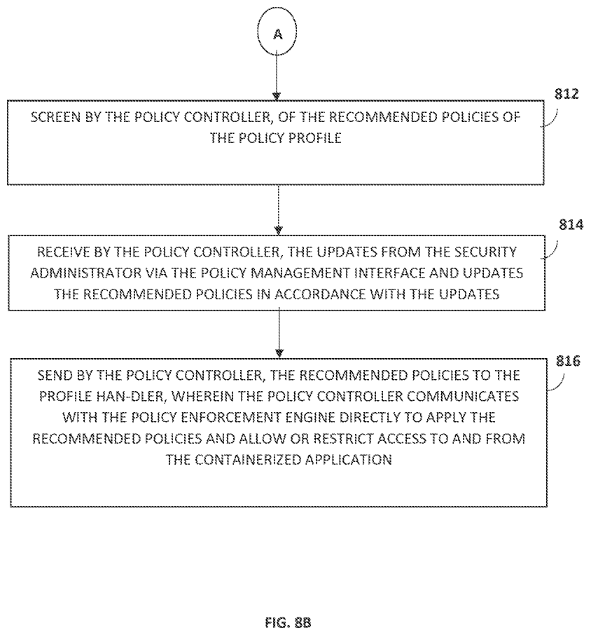

FIGS. 8A-8B depicts a flow chart of method for specifying and managing predefined policies for containerized workloads, in accordance with an embodiment. At step 802, an application developer provides a specification of the policy profile for a containerized application and an associated link element via a policy management interface and storing the container image containing the link element associated with the policy profile in a container registry. At step 804, a profile handler module 106 detects and monitors events of containerized applications. At step 806, a profile handler module 106 detects a link element associated with the policy profile by scanning through container images in the container registry, in response to one or more of the events a pod start-up event or a container start-up event. At step 808, a profile handler module 106 fetches the policy profile of the containerized application associated with the link element from the container registry and transmitting the policy profile to a policy controller module. At step 810, the policy controller module 108 obtains one or more recommended policies of the policy profile from the policy server 203 or a static file. At step 812, the policy controller module 108 screens the recommended policies of the policy profile. At step 814, the policy controller module 108 receives the updates from the security administrator via the policy management interface 102 and updates the recommended policies in accordance with the update. At step 816, the policy controller module 108 sends the recommended policies to the profile handler module. The policy controller module 108 communicates with the policy enforcement engine directly to apply the recommended policies and allow or restrict access to and from the containerized application.

According to an embodiment herein, the framework of the system disclosed herein executes the method disclosed herein in any containerized or container runtime platform, for example, Docker®, Linux containers (LXC), etc. Containerized applications may or may not be deployed with the k8s orchestration engine. Even without the k8s orchestration engine in place, the host of the containerized applications may want to enforce policy controls using the framework for predefined policy specification disclosed herein. In these embodiments, the discovery of the URL is based, for example, on docker/container APIs. The embodiments herein simplify the procedure for security policy discovery for containers and provide container-application developers with control over the policy profile, as the container-application developers determine the purpose of the containers. The policy profiles specified and created by the container-application developers, therefore, ensure that the right/least set of privileges are exposed to the container on a node. The embodiments herein remove the need for intrusive instrumentation of the traffic and the requirement to send rich telemetry to a remote node for observation of the traffic patterns. The embodiments herein reduce false positives since the recommended policy profiles are specified by the application developer community. The policy profiles are configured to be improved over a period of time because the updates can be shared by the users of the containers with the application developers. Moreover, to address data-plane performance impact due to instrumentation, the system and the methods disclosed herein enforce policy controls without having to dynamically discover the set of policies based on network flows or based on system calls. The embodiments herein fetch the policy controls based on the container image. These policy controls are pre-populated on the policy server 203 by the application developer or the development community.

The system and the methods disclosed herein are applicable in security products that provide runtime policy enforcement solutions for containerized workloads, as these runtime policy enforcement solutions require a specification of a set of policies to enforce, thereby alleviating the task of policy discovery. The system and the methods disclosed herein address the challenges in network flow policy discovery and system policy discovery by allowing application developers to specify a static URL as part of the container image; by providing a mechanism to discover the URL as part of a pod/container start-up; and by applying policy transformation in context to local deployments. The system and the methods disclosed herein allow security products to apply policy enforcement on container operations. The system and the methods disclosed herein are also applicable in security products that apply Advanced Malware Protection (AMP). The system and the methods disclosed herein are also applicable in information security products, data security products, network security products, and application centric security products

A “non-transitory computer-readable medium” for purposes of embodiments of the present invention may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location or have temporal limitations. For example, a processor can perform its functions in “real time,” “offline,” in a “batch mode,” etc. Portions of processing can be performed at different times and at different locations, by different (or the same) processing systems.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code will include at least one processor coupled directly or indirectly to memory elements through a system bus. The memory elements can include local memory employed during actual execution of the program code, bulk storage, Subscriber Identity Module (SIM) card, and cache memories which provide temporary storage of at least some program code in order to reduce the number of times code must be retrieved from bulk storage during execution. Input/output (I/O) devices (including but not limited to keyboards, displays, pointing devices, remote controls, camera, microphone, temperature sensor, accelerometer, gyroscope, etc.) can be coupled to the system either directly or through intervening l/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing examples and illustrative implementations of various embodiments have been provided merely for explanation and are in no way to be construed as limiting of the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims.

What is claimed is:

1. A system for specifying and managing pre-defined policies for containerized workloads, the system comprising:
a memory comprising one or more executable modules and a set of programmable instructions to be executed on a hardware processor; and
wherein the hardware processor operatively coupled with the memory and loaded with one or more modules for specifying and managing pre-defined policies for containerized workloads, and wherein the one or more modules comprising:
a policy management module/interface for receiving from an application developer, a specification of a policy profile defining one or more policies for a containerized application and a link element associated with the policy profile, a container image containing or the link element associated with the policy profile, and wherein the policy management module stores the container image in a container registry or in a K8s pod of a policy server, and wherein the link element is a static Uniform Resource Locator (URL) that links to the policy profile or a static file containing the policy profile;
a (K8 pod) start-up engine module configured for auto-detecting if a container contains a uniform resource locator (URL) or a profile;
a profile handler module operably coupled to a policy enforcement engine for enforcing policies for the containerized workloads, and wherein the profile handier module is configured for:
detecting and monitoring one or more events of containerized applications, and wherein the one or more of the events comprises at least a pod start-up event or a container start-up event;
detecting by a profile handler module, a link element associated with the policy profile (URL or profile) by scanning through container images in the container registry, in response to the detection of one or more of the events; and
fetching the policy profile of the containerized application associated with the link element from the container registry and transmitting the policy profile to a policy controller module; and wherein the policy controller module is configured for obtaining the one or more policies of the policy profile from the policy server or a static file, and wherein the policy controller module is configured for screening the recommended policies of the policy profile, and wherein the policy controller module is configured for receiving the updates from a security administrator via the policy management interface and updating the one or more policies in accordance with the updates, and wherein the policy controller module is configured for sending the recommended policies to the profile handler module, and wherein the profile handler module, in communication with the policy enforcement engine, is configured to facilitate an execution of the recommended policies of the policy profile for the containerized application, and wherein the security administrator is configured to modify or add additional rule sets to the received one or more policies via the policy management interface and subsequently apply the modified or updated policies in context to the containerized application.

2. The system of claim 1, wherein the policy controller module is configured to communicate with the policy enforcement engine directly to apply the one or more policies and allow or restrict access to and from the containerized application, and wherein the policy controller is configured to bypass the profile handler and directly communicate with the policy enforcement engine for enforcement of the recommended policies.

3. The system of claim 1, wherein the policy management module allows the policy controller module to watch/search for pod/container events and update the policies profile based on such events, and wherein policies are grouped together based on the set of labels which encompass multiple containers.

4. The system of claim 1, wherein the policy controller module checks if the given container already has an enforced policy based on the recommended set, upon the existence of the enforced policy, the policy controller module ignores corresponding rules and upon non-existence of the enforced policy the policy controller module recommends the corresponding rules to an admin.

5. The system of claim 1, wherein the profile handler module, the policy server, and the policy controller module are programmable using high-level computer programming languages, wherein the policy enforcement engine operates at network level to apply network policies and at applications level or systems level to apply system policies.

6. The system of claim 1, wherein the application developer, associates a link element with the policy profile within a container image of the containerized application, and pushes the policies of the policy profile to the policy server.

7. The system of claim 1, wherein the policy management module allows the user to upload a static URL as part of the container image.

8. The system of claim 1, the policy server is configured to store the one or more policies of the policy profile of the containerized application, when the link element is a static URL that links to the policy profile.

9. The system of claim 1, wherein the policy controller module is configured to check if a given container already has an enforced policy based on a recommended set of policies, and wherein the policy controller is configured to ignore corresponding rules upon the existence/detection of the enforced policy, and wherein the policy controller module is configured to recommend the corresponding rules to an administrator module, upon non-existence/non-detection of the enforced policy.

10. A computer implemented method comprising instructions stored on a non-transitory computer readable storage medium and executed on a hardware processor in a computing device provided with memory, for specifying and managing predefined policies for containerized workloads through one or more applications or algorithms, the method comprising the steps of:
providing by an application developer, a specification of a policy profile for a containerized application and an associated link element via a policy management module and storing a container image containing a link element associated with the policy profile in a container registry;
detecting and monitoring, using a profile handler module, events of containerized applications;
detecting, using the profile handler module, a link element associated with the policy profile by scanning through one or more container images in the container registry, in response to one or more of the events comprising at least a pod start-up event or a container start-up event;
fetching, using the profile handler module, the policy profile of the containerized application associated with the link element from the container registry and transmitting the policy profile to a policy controller module;
obtaining by the policy controller module, one or more recommended policies of the policy profile from the policy server or astatic file;
screening by the policy controller module, the one or more recommended policies of the policy profile;
receiving by the policy controller module, one or more updates from the security administrator via the policy management interface and updating the recommended policies in accordance with the one or more updates; and
sending by the policy controller module, recommended policies to the profile handler module.

11. The method of claim 10, wherein the link element is a static file containing the policy profile, the policy controller module directly processes the recommended policies from the policy profile without having to dynamically fetch the recommended policies from the policy server.

12. The method of claim 10, wherein the link element is a static Uniform Resource Locator (URL), the policy controller module, in communication with the profile handler module, fetches the recommended policies of the fetched policy profile from the policy server.

13. The method of claim 10, wherein the policy controller module bypasses the profile handler module and communicates with a policy enforcement engine for enforcement of the recommended policies.

14. The method of claim 10, wherein the container image contains a link element, a URL for which the contents are dynamically fetched from the policy server using the policy controller module.

15. The method of claim 10, wherein the URL is resolved at runtime to fetch the policy from a remote repo.

16. The method of claim 10, wherein the policy is directly placed inside the container image as a static file.

17. The method of claim 10, wherein the security administrator chooses to modify or add additional rule sets to the policy and subsequently accepts the policy in context to the container/pod.

18. The method of claim 10, wherein the profile handler module is an on-node process/daemon configured to communicate with the policy controller module to fetch the policies.

19. One or more non-transitory computer readable storage mediums storing one or more sequences of instructions, which when executed by one or more processors, causes a method for specifying and managing predefined policies for containerized workloads, the method comprising;
providing by an application developer, a specification of a policy profile for a containerized application and an associated link element via a policy management interface and storing a container image containing a link element associated with the policy profile in a container registry;
detecting and monitoring by a profile handler module, events of containerized applications;
detecting by the profile handler module, a link element associated with the policy profile by scanning through one or more container images in the container registry, in response to one or more of the events comprising at least a pod startup event or a container start-up event;
fetching by the profile handler module, the policy profile of the containerized application associated with the link element from the container registry and transmitting the policy profile to a policy controller module;
obtaining by the policy controller module, one or more recommended policies of the policy profile from the policy server or astatic file;
screening by the policy controller module, the one or more recommended policies of the policy profile;
receiving by the policy controller module, one or more updates from the security administrator via the policy management interface and updating the recommended policies in accordance with the one or more updates; and
sending by the policy controller module, recommended policies to the profile handler module.

20. The method of claim 20, wherein the link element is a static file containing the policy profile, the policy controller module directly processes the recommended policies from the policy profile without having to dynamically fetch the recommended policies from the policy server, and wherein the link element is a static Uniform Resource Locator (URL), the policy controller module, in communication with the profile handler module, fetches the recommended policies of the fetched policy profile from the policy server, and wherein the policy controller module bypasses the profile handler module and directly communicates with the policy enforcement engine for enforcement of the recommended policies.
